(19) United States
(12) Patent Application Publication
(10) Pub. No.: US 2005/0105719 A1
(43) Pub. Date: May 19, 2005

(54) Personal information control and processing

(76) Inventor: Satoshi Hada, Tokyo-to (JP)

Correspondence Address: IBM CORPORATION, T.J. WATSON RESEARCH CENTER, P.O. BOX 218, YORKTOWN HEIGHTS, NY, 10598, US

(21) Appl. No.: 10/974,923

(22) Filed: Oct. 27, 2004

(30) Foreign Application Priority Data
Oct. 30, 2003 (JP) 2003-369884

(51) Int. Cl. H04K 1/00; H04L 9/00

(52) U.S. Cl. 380/28; 713/168

(57) ABSTRACT

The present invention provides a personal information controlling system that limits use of personal information stored in a storage device. An example of a system comprises: controlling means for controlling a privacy policy for each piece of personal information in connection with a specified available period in which a user of the personal information is allowed to use the personal information, the privacy policy being information specifying the available period; key acquiring means for acquiring a cipher key for a cipher that can be deciphered by an administrator of the privacy policy and that cannot be deciphered by the user of the personal information; and ciphering means for using the cipher key acquired by the key acquiring means to cipher the personal information so that the user cannot use the personal information if the available period specified by the privacy policy has expired.

### FIELD OF THE INVENTION

The present invention relates to a personal information controlling system, an information processing system, a personal information controlling method, a program, and a storage medium. In particular, the present invention relates to a personal information controlling system, an information processing system, a personal information controlling method, a program, and a storage medium in which personal information is handled in accordance with predetermined rules.

### BACKGROUND ART

In recent years, more and more enterprises have collected personal information from their clients to use it for marketing or the like. Correspondingly, laws or the like for protecting personal information have been established throughout the world. Further, more and more attention has been paid to technologies to enable the enterprises to properly control the personal information on their clients.

For example, if any enterprise has handled personal information on its client in accordance with a certain privacy policy, it may have to delete the personal information. By way of example, according to the privacy policy of COPPA (Children's Online Privacy and Protection Act), the mail addresses of children of 13 or younger shall be deleted within 90 days unless their parents consent the opposite.

Specifically, enterprises control private information in association with a privacy policy. If the conditions specified in the privacy policy are established, the enterprise carries out, for example, deletion of the personal information. In the above example, the privacy policy includes parents' consent. The enterprise determines whether or not to delete personal information on children of 13 or younger, on the basis of the contents of the privacy policy.

Consideration is made to the following documents:

[Non-Patent Document 1]

W3C Recommendation, The Platform for Privacy References 1.0 (P3P1.0) Specification, 16 Apr. 2002.

[Non-Patent Document 2]

IBM Research Report, Enterprise Privacy Authorization Language (EPAL) http://www.zurich.ibm.com/security/enterprise-privacy/epal/Specification/index.html

[Non-Patent Document 3]

A. Shamir, “Identity-based cryptosystems and signature schemes”, CRYPTO'84, pp. 47-53, 1984.

[Non-Patent Document 4]

D. Boneh and M. Franklin, “Identity based encryption from the Weil pairing”, SIAM J. of Computing, Vol. 32, No. 3, pp. 586-615, 2003.

For methods describing a privacy policy, refer to Non-Patent Documents 1 and 2.

Furthermore, in recent years, ciphering technologies such as a secret key cipher and a public key cipher have advanced in order to keep the contents of communications secret between a sender and a receiver. An identity-based encryption (IBE) has hitherto been used as a kind of public key cipher (refer to Non-Patent Documents 3 and 4). According to the IBE, data such as a name or an e-mail address can be used directly as a public key. Thus, the user of the public key can simplify a process of acquiring the public key of the receiver. This is generally efficient.

However, once the enterprise has actually deleted the personal information, if the client complains after the deletion that, for example, “the client's personal information has been inappropriately handled”, then the enterprise does not have any means for checking how the personal information has actually been handled.

For example, it is assumed that the private policy is specified as follows:
1. A client's mail address shall be deleted 90 days after reception.
2. Advertising mails may be sent to the mail address within 90 days with the client's consent.

The personal information contains the client's mail address and information indicating the client's consent. It is further assumed that the client consents to the sending of advertising mails and that the enterprise sends a number of advertising mails to the address within 90 days and subsequently deletes the personal data. After the deletion, if the client makes complaints about the “sending of the advertising mails”, the enterprise cannot execute any checks because the personal information has already been deleted.

### SUMMARY OF THE INVENTION

It is thus an aspect of the present invention to provide a personal information controlling system, an information processing system, a personal information controlling method, a program, and a storage medium all of which can solve the above problems. This aspect is accomplished by combining the characteristics set forth in the independent claims. The dependent claims set forth further advantageous specific examples of the present invention.

To accomplish the above aspect, the present invention provides a personal information controlling system that limits use of personal information stored in a storage device, the system comprising controlling means for controlling a privacy policy for each piece of personal information in connection with a specified available period in which a user of the personal information is allowed to use the personal information, the privacy policy being information specifying the available period, key acquiring means for acquiring a cipher key for a cipher that can be deciphered by an administrator of the privacy policy and that cannot be deciphered by the user of the personal information, and ciphering means for using the cipher key acquired by the key acquiring means to cipher the personal information so that the user cannot use the personal information if the available period specified by the privacy policy has expired.

This aspect also provides a program that allows a computer to work as the personal information controlling system, a storage medium in which the program is recorded, a personal information controlling method using the personal information controlling system, and an information processing system having the personal information controlling system.

The above summary of the present invention does not list all the required characteristics of the present invention. Sub-combinations of the group of characteristics also constitute inventions. Thus, the present invention enables personal information to be appropriately controlled.

### BRIEF DESCRIPTION OF THE DRAWINGS

These, and further, aspects, advantages, and features of the invention will be more apparent from the following detailed description of a preferred embodiment and the appended drawings wherein:

FIG. 1 is a block diagram of an information processing system 10;

FIG. 2 is a diagram showing an example of a process in which a user terminal 40-1 uses personal information;

FIG. 3 is a chart showing the operational flow of a process in which a personal information controlling system 30 ciphers personal information;

FIG. 4 is a chart showing the operational flow of a process in which the personal information controlling system 30 deciphers the personal information;

FIG. 5 is a block diagram of the information processing system 10 according to a variation;

FIG. 6 is a chart showing the operational flow of a process in which the personal information controlling system 30 ciphers personal information according to the variation;

FIG. 7 is a chart showing the operational flow of a process in which the personal information controlling system 30 deciphers the personal information according to the variation; and

FIG. 8 is a diagram showing an example of the hardware configuration of a computer 500 that implements the personal information controlling system 30.

### DESCRIPTION OF SYMBOLS

10 . . . Information processing system
20 . . . Storage device
30 . . . Personal information controlling system
40 . . . User terminal
50 . . . Personal terminal
60 . . . Key issuing institution server
300 . . . Controlling means
310 . . . Key acquiring means
320. Ciphering means
330 . . . Key generating means
340 . . . Inquiry target input means
350 . . . Deciphering means
500 . . . Computer

### DETAILED DESCRIPTION OF THE INVENTION

The present invention provides personal information controlling systems, information processing systems, personal information controlling methods, programs, and storage media all of which can solve the above described problems. In an example of a personal information controlling system that limits use of personal information stored in a storage device, the system comprises: controlling means for controlling a privacy policy for each piece of personal information in connection with a specified available period in which a user of the personal information is allowed to use the personal information, wherein the privacy policy being information specifying the available period; key acquiring means for acquiring a cipher key for a cipher that can be deciphered by an administrator of the privacy policy and that cannot be deciphered by the user of the personal information; and ciphering means for using the cipher key acquired by the key acquiring means to cipher the personal information so that the user cannot use the personal information if the available period specified by the privacy policy has expired.

Other embodiments provide a program that allows a computer to work as the personal information controlling system, a storage medium in which the program is recorded, a personal information controlling method using the personal information controlling system, and an information processing system having the personal information controlling system.

Although, this description of the present invention does not list all the required characteristics of the present invention, sub-combinations of the group of characteristics also constitute inventions. Thus, the present invention enables personal information to be appropriately controlled.

The present invention will be described below with reference to its embodiments. However, the embodiments below do not limit the invention according to the claims. Not all the combinations of the characteristics described in the embodiments are essential to the solution of the present invention.

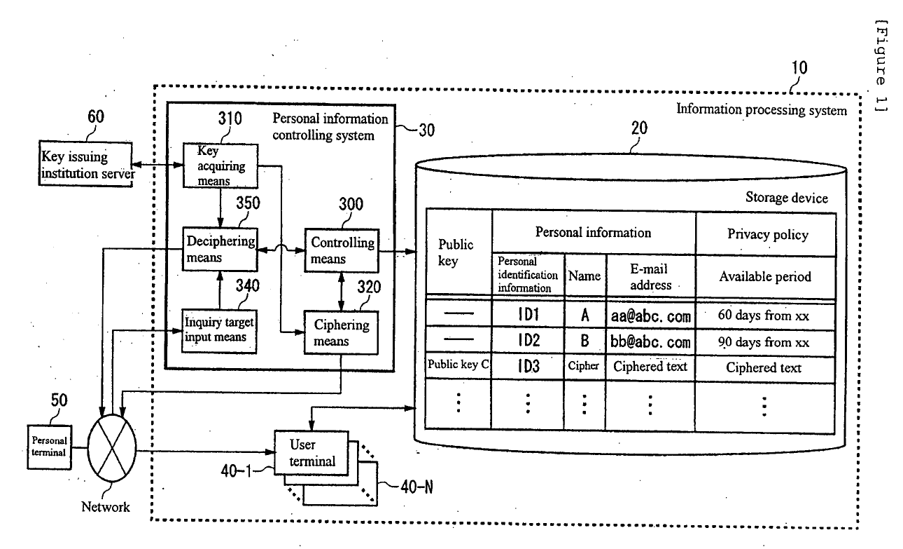

FIG. 1 is a block diagram of an information processing system 10. The information processing system 10 is controlled by a data administrator that is an enterprise or the like which carries out marketing using a WWW (World Wide Web) system. The information processing system 10 is intended to appropriately control personal information collected from individuals and the like.

The information processing system 10 has a storage device 20, a personal information controlling system 30, and user terminals 40-1 to 40-N. The storage device 20 stores personal information. The personal information controlling system 30 is controlled by a privacy policy administrator that performs control within the organization of the data administrator so as to make a privacy policy properly observed. The personal information controlling system 30 limits the use of the personal information stored in the storage device 20 in accordance with the privacy policy.

Each of the user terminals 40-1 to 40-N is controlled, within the organization of the data administrator, by a personal information user that uses personal information. Each of the user terminals 40-1 to 40-N receives personal information from a personal terminal 50 controlled by an individual. The user terminal then stores the received personal information in the storage device 20. Each of the user terminals 40-1 to 40-N reads personal information from the storage device 20 for use on the basis of an instruction from a personal information user. A key issuing institution server 60 is controlled by a third party institution trusted by both data administrator, controlling the information controlling system 10, and individual, controlling the personal terminal 50. The key issuing institution server 60 executes a process of issuing a cipher key on the basis of an instruction from the information processing system 10.

The personal information controlling system 30 has controlling means 300, key acquiring means 310, ciphering means 320, inquiry target input means 340, and deciphering means 350. The controlling means 300 controls a privacy policy for each piece of personal formation for a specified available period in which the personal information user is allowed to use personal information; the privacy policy is information specifying the available period. For example, the controlling means 300 controls the privacy policy by storing it in the storage device 20 in association with personal information. Moreover, if the personal information is ciphered, the controlling means 300 may control a public key for the public key ciphering system used for ciphering, in association with the ciphered personal information.

Here, the personal information contains personal identification information that identifies an individual specified by the personal information, the name of the individual identified by the personal information, and the e-mail address of the individual identified by the personal information. The personal information may also contain the individual's birth date, age, address, and telephone number, and the results of questionnaires filled in by the individual. In addition to these pieces of information indicating the individual's attributes, the personal information may contain information indicating whether or not the individual consents to the use of the personal information for marketing or the like.

The privacy policy may specify not only the available period in which the personal information user is allowed to use the personal information but also other matters. For example, the privacy policy may specify application and purposes for which the personal information is allowed to be used.

The key acquiring means 310 acquires, from the key issuing institution server 60, a cipher key that can be deciphered by a privacy policy administrator and that cannot be deciphered by the personal information user. The key acquiring means 310 then sends the cipher key to the ciphering means 320. For example, the key acquiring means 310 acquires, from the key issuing institution server 60, a public key for the public key ciphering system for which the privacy policy administrator controls a secret key and for which the personal information user does not control the secret key.

Specifically, in response to a request from the privacy policy administrator or the administrator of the personal terminal 50, the key issuing institution server 60 discloses and sends the secret key to the personal information controlling system 30 or the like. On the other hand, the key issuing institution server 60 refrains from disclosing the secret key depending on the request from the personal information user. Thus, the secret key is controlled so as to be disclosed to the privacy policy administrator if required. On the basis of an instruction from the privacy policy administrator, the key acquiring means 310 may acquire the secret key corresponding to the public key from the key issuing institution server 60 and send it to the deciphering means 350.

If the available period specified by the privacy policy has expired, the ciphering means 320 uses the cipher key acquired by the key acquiring means 310, for example, the public key for the public key ciphering system to cipher the personal information stored in the storage device 20 so that the personal information user cannot use the information. For example, the ciphering means 320 may cause the controlling means 300 to read the personal information and cipher the read personal information. The ciphering means 320 may then cause the controlling means 300 to store the ciphered personal information in the storage device 20. Then, after ciphering the personal information, the ciphering means 320 further outputs a notice to personal terminal 50 indicating that it has ciphered the personal information.

The inquiry target input means 340 receives an inquiry as to whether or nor a certain piece of personal information is unfairly used, together with the personal information. On condition that the deciphering means 350 receives an instruction from the privacy policy administrator, it receives the secret key used to decipher personal information from the key acquiring means 310, which is stored in the storage device 20 after being ciphered. Subsequently, the deciphering means 350 causes the controlling means 300 to read the ciphered personal information. The deciphering means 350 uses the secret key to decipher the personal information read by the controlling means 300. Then, the deciphering means 350 compares the deciphered personal information with the personal information inputted by the inquiry target input means 340. The deciphering means 350 then outputs the result of the comparison to the personal terminal 50.

As described above and shown in FIG. 1, if the available period has expired, in which the personal information stored in the storage device 20 is allowed to be used, the personal information controlling system 30 ciphers the personal information so that the personal information user cannot use the personal information, instead of deleting the personal information. It is thus possible to allow the personal information to be used only during the available period. It is also possible to deal properly with an inquiry about the personal information even after the available period has expired.

Since the personal information controlling system 30 uses the cipher key for the public key ciphering system to cipher the personal information, it does not have any decipher key used to decipher the personal information compared to the use of common key cipher. This makes it possible to prevent the data administrator controlling the information processing system 10 from unfairly using the personal information against the privacy policy.

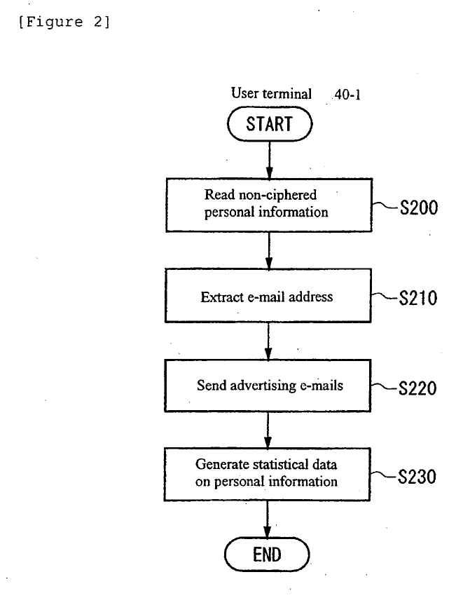

FIG. 2 shows an example of a process in which the user terminal 40-1 uses the personal information. The user terminals 40-2 to 40-N execute almost the same process as that executed by the user terminal 40-1. Accordingly, their description will be omitted. On the basis of an instruction from the personal information user, the user terminal 40-1 selects plural pieces of personal information which are included in the plural pieces of information stored in the storage device 20 and which are not ciphered by the ciphering means 320. The user terminal 40-1 then reads these pieces of information from the storage device 20 (S200). Then, the user terminal 40-1 extracts the individuals e-mail address from the read personal information (S210).

Then, the user terminal 40-1 uses the read personal information by sending advertising e-mails to the extracted e-mail address (S220). Further, the user terminal 40-1 may use the personal information by generating statistical data on the plural pieces of personal information not ciphered by the ciphering means 320 (S230).

FIG. 1 shows only an example of the use of personal information. Alternatively, on the basis of an instruction from the personal information user, each of the user terminals 40-1 to 40-N may display the personal information to the personal information user or may read data indicating the personal information from the storage device 20 and then process and output the read data.

As described above and shown in FIG. 1, each of the user terminals 40-1 to 40-N uses only the personal information stored in the storage device 20 without being ciphered, for advertising, marketing, or the like. On the other hand, each of the user terminals 40-1 to 40-N cannot read ciphered personal information from the storage device 20 for use. Thus, each of the user terminals 40-1 to 40-N can read and use personal information only during the available period specified by the privacy policy without the need to control the available period specified by the privacy policy.

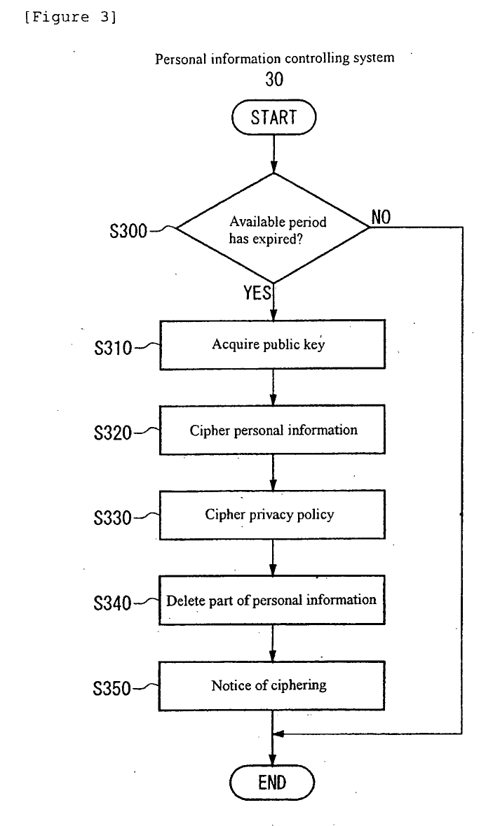

FIG. 3 shows the operational flow of a process in which the personal information controlling system ciphers personal information. The personal information controlling system 30 periodically executes the process shown below, on each of the plural pieces of information stored in the storage device 20 without being ciphered. First, the ciphering means 320 determines whether or not the available period specified by the privacy policy for a certain piece of personal information has expired (S300). If the available period has not expired (S300: NO), the process is ended.

On the other hand, if the available period has expired, the key acquiring means 310 acquires, from the key issuing institution server 60, a cipher key that can be deciphered by the privacy policy administrator and that cannot be deciphered by the personal information user, for example, a public key for a public key ciphering system (S310).

Specifically, first, the key acquiring means 310 instructs the key issuing institution server 60 to generate a pair of a public and a secret key for the public key ciphering system. Then, the key acquiring means 310 acquires only the public key of the generated set from the key issuing institution server 60.

The process in which the key issuing institution server 60 generates a pair of a public key and a secret key is expressed by Equation (1), shown below. In this equation, pk denotes the public key, sk denotes the secret key, and KeyPairGen denotes a function that generates the pair of the public key and the secret key.
(pk, sk)=KeyPairGen( ) (1)

Preferably, the key issuing institution server 60 generates a pair of a public key and a secret key which varies with personal information to be ciphered. Then, the key issuing institution server 60 stores and retains the generated public and secret keys in itself even after the key acquiring means 310 has acquired the public key.

The ciphering means 320 uses the public key acquired by the key acquiring means 310 to cipher the personal information stored in the storage device 20 so that the personal information user cannot use the personal information (S320). Moreover, the ciphering means 320 uses this public key to cipher the privacy policy corresponding to the personal information (S330). Equation (2), shown below, expresses the process in which the ciphering means 320 ciphers the personal information and the privacy policy. In this equation, cipher denotes a ciphered text resulting from ciphering, data denotes the personal information, policy denotes the privacy policy, and | denotes concatenation of data items. Further, Encrypt denotes a function of a ciphering process, and data|policy, a ciphering target, is ciphered using a public key pk obtained by the key acquiring means 310 in step S310, with cipher, the result of the ciphering, outputted.
cipher Encrypt (pk, data|policy) (2)

The ciphering means 320 stores, in the storage device 20, the ciphered text resulting from the ciphering instead of the personal information and privacy policy. In this case, the ciphering means preferably further stores, in the storage device 20, the personal identification information on the individual identified by the personal information and the public key used for the ciphering in association with the ciphered text. For example, as shown in the storage device 20 in FIG. 1, the ciphering means 320 stores ID3, the personal identification information, and the public key C in the storage device 20 in FIG. 1, in association with the ciphered text. Thus, the deciphering means 350 can carry out appropriate deciphering while preventing the use of the specific contents of the personal information.

For example, the data stored by the ciphering means 320 in the storage device 20 is expressed by Equation (3), shown below. In this equation, oid|did|mid|pid denotes the personal identification information. Specifically, oid denotes the individual identified by the personal identification information, and did denotes information identifying the personal information and included in the plural pieces of personal information stored in the storage device 20. Further, mid denotes information identifying the data administrator, controlling the information process system 10, and pid denotes information identifying the privacy policy.
pk|oid|did|mid|pid|cipher (3)

Subsequently, the ciphering means 320 may delete a part of the ciphered personal information (S340). For example, the ciphering means 320 may keep storing personal identification information, included in the personal information and identifying the individual, instead of deleting it and delete information such as the individual's telephone number.

The order of steps S340 and S330 is not limited to the example shown in FIG. 1. For example, if the personal information and the privacy policy are integrally ciphered, it may be impossible to properly decipher the ciphered text depending on the type of the ciphering if a part of the ciphered text is deleted. In this case, the ciphering means 320 desirably deletes a part of the ciphered text and then ciphers the remaining undeleted personal information. Subsequently, if the ciphering means 320 ciphers the personal information, it outputs a notice to the personal terminal 50 identified by the ciphered personal information, the notice indicating that it has ciphered the personal information (S350).

Thus, if the available period specified by the privacy policy has expired, the personal information controlling system 30 ciphers the personal information so that the personal information user cannot use the personal information. In this case, the key acquiring means 310 acquires, from the key issuing institution server 60, a public key varying with the personal information to be ciphered. The ciphering means 320 ciphers the personal information on the basis of the public key varying with the personal information. As a result, even if one of the plural pieces of personal information is deciphered, the decipher key used for the deciphering cannot be used for the other pieces of the personal information. Thus, the privacy policy administrator can more appropriately control the privacy policy.

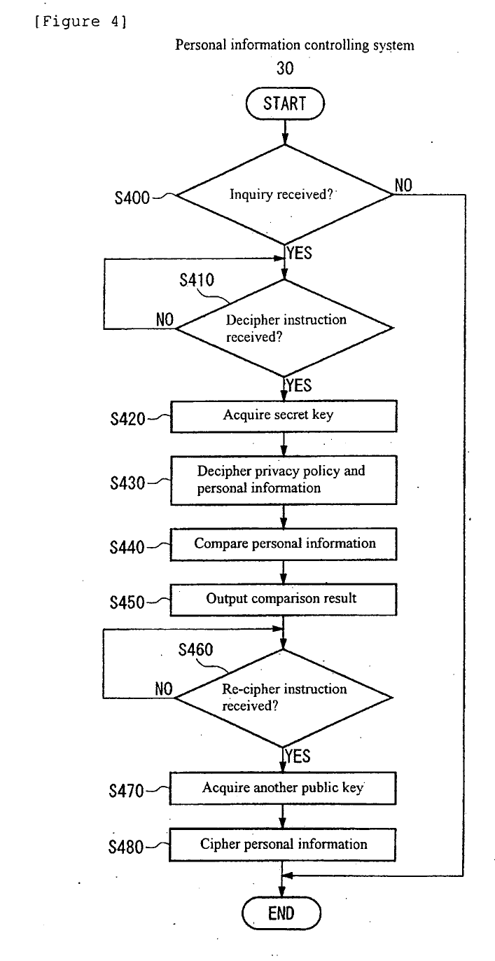

FIG. 4 shows the operational flow of a process in which the personal information controlling system 30 deciphers personal information. The personal information controlling system 30, for example, periodically executes the process shown below, on each of the plural pieces of personal information stored in the storage device 20 after being ciphered by the ciphering means 320. The inquiry target input means 340 determines whether or not it has received an inquiry as to whether a certain piece of personal information has been unfairly used, together with that personal information (S400). If the inquiry target input means 340 has not received such an inquiry (S400: NO), it ends the process.

If the inquiry target input means 340 has received such an inquiry (S400: YES), the deciphering means 350 determines whether or not it has received a deciphering instruction from the privacy policy administrator, the deciphering instruction permitting the personal information to be deciphered (S410). If the deciphering means 350 has received such a deciphering instruction (S410: YES), the key acquiring means 310 acquires a secret key for the public key ciphering system from the key issuing institution server 60 (S420). Specifically, the key acquiring means 310 may execute the process shown below to acquire the secret key generated by the key issuing institution server 60 in step S310 in FIG. 3.

First, the key acquiring means 310 uses the personal identification information of the personal information for the inquiry as a key to search the storage device 20 for the public key used for ciphering the personal information. The key acquiring means 310 sends the public key retrieved to the key issuing institution server 60. The key issuing institution server 60 returns the secret key corresponding to this public key to the key acquiring means 310. Thus, the key acquiring means 310 can acquire the secret key used to decipher the personal information, from the key issuing institution server 60.

Subsequently, the deciphering means 350 uses the secret key sk acquired by the key acquiring means 310 in step S420 to decipher the privacy policy and the personal information (S430). The deciphering process is expressed by Equation (4), shown below. In this equation, Decrpt denotes a function to decipher the ciphered text to restore the personal information. Specifically, cipher, the personal information and privacy policy ciphered by the ciphering means 320, is deciphered using the secret key sk acquired by the key acquiring means 310. As a result, data|policy, the personal information and privacy policy, is outputted.
data|policy =Decrypt (sk, cipher) (4)

The deciphering means 350 compares the deciphered personal information with the personal information inputted by the inquiry target input means 340 (S440). The deciphering means 350 then outputs the result of the comparison to the personal terminal 50 (S450). Then, if the personal information as the inquiry target can be determined not to have been used for marketing or the like, then it is possible to indicate to the inquirer that the personal information is unlikely to have been unfairly used.

Alternatively, the deciphering means 350 may compare only a part of the personal information instead of the whole of the information. For example, the deciphering means 350 may compare only the e-mail address, a part of the personal information and output the result of the comparison. Thus, in response to an inquiry as to whether or not the e-mail address has been unfairly used, the deciphering means 350 can compare only the inquiry target, that is, the e-mail address and output the result of the comparison.

Alternatively, the deciphering means 350 may compare the individual's address, telephone number, birth date, or family members, which is a part of the personal information. Alternatively, the deciphering means 350 may output the deciphered personal information or privacy policy to the personal terminal 50 or the like.

If the key acquiring means 310 receives an instruction on re-ciphering of the deciphered personal information from the privacy policy administrator (S460: YES), it acquires, from the key issuing institution server 60, a public key different from the one for the cipher deciphered by the deciphering means 350 (S470). The key acquiring means 310 may acquire the different public key from the key issuing institution server 60 simultaneously with the acquisition of the secret key in step S420.

Then, the ciphering means 320 uses the public key acquired by the key acquiring means 310 to re-cipher the personal information (S480). This makes it possible to avoid the unfair use of the secret key already disclosed to the personal information controlling system 30. Therefore, the re-ciphered personal information can be prevented from being unfairly read.

As shown above in FIGS. 1 to 4, the personal information controlling system 30 ciphers personal information used inside an enterprise or the like, the data administrator, so that the personal information user cannot use the personal information if the period in which the personal information is allowed to be used has expired. This makes it possible to make the privacy policy properly observed and to appropriately deal with an inquiry about, for example, the unfair use of the personal information after the expiry of the available period.

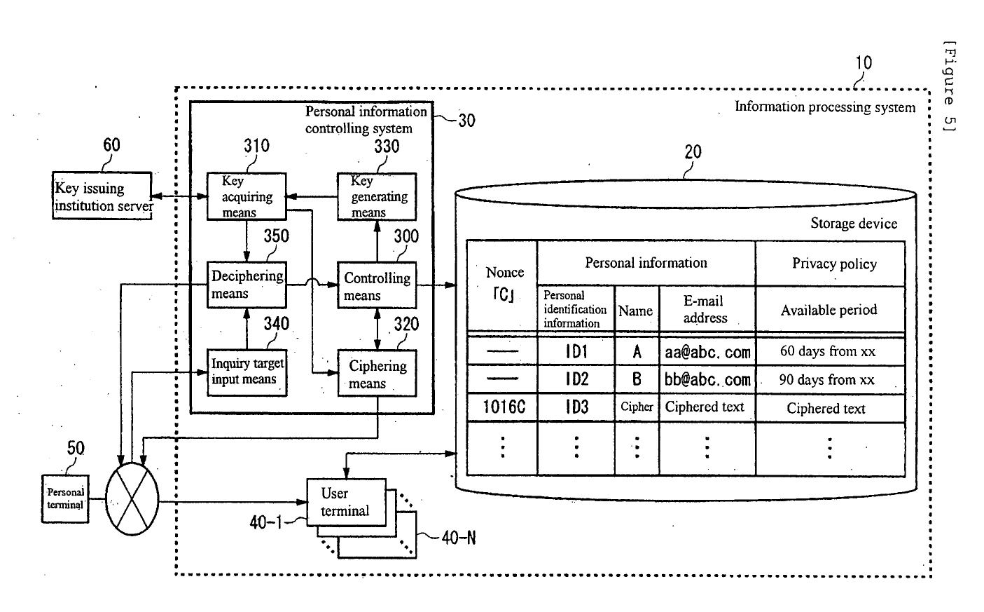

In the present example, the information processing system 10 acquires a public key from the key issuing institution server 60 every time personal information is ciphered. If the information processing system 10 ciphers a large amount of personal information at a time, the public key acquired by the information processing system 10 is large in size. This may result in a large traffic between the information processing system 10 and the key issuing institution server 60 and thus an increase in communication cost. FIGS. 5 to 7 show a variation that prevents such an increase in traffic to accomplish efficient processing.

FIG. 5 is a block diagram of the information processing system 10 according to the variation. In conjunction with the present example, description will be given of an example in which the personal information controlling system 30 ciphers personal information using a different method. In the present example, the personal information controlling system 30 is the personal information controlling system 30 shown in FIG. 1 and further comprising key generating means 330. The other arrangements are substantially the same as those of the personal information controlling system 30 shown in FIG. 1. Accordingly, only differences from the personal information controlling system 30 shown in FIG. 1 will be described.

The key generating means 330 acquires, from the storage device 20, the personal identification information identifying the individual specified by personal information. Then, on the basis of the personal identification information the key generating means 330 generates a cipher key for a cipher for which the privacy policy administrator controls a decipher key and for which the personal information user does not control the decipher key. Then, the key acquiring means 310 acquires the cipher key from the key generating means 330, the cipher key having been generated by the key generating means 330. Further, in response to an instruction from the privacy policy administrator, the key acquiring means 310 acquires a decipher key used to decipher the personal information, from the key issuing institution server 60 based on the personal identification information of personal information as an inquiry target.

The ciphering means 320 uses the cipher key based on the personal identification information to cipher the personal information on the basis of identity-based encryption (IBE). Alternatively, the ciphering means 320 may use information such as the individual's name or e-mail address which indicates an attribute of the individual, as a cipher key for the identity-based encryption. Here, the identity-based encryption enables published information such as the individual's name to be used as a cipher key. With this cipher, only the key issuing institution server 60 can generate a decipher key. The key issuing institution server 60 discloses the decipher key only to the privacy policy administrator or the administrator of the personal terminal 50.

Preferably, the ciphering means 320 uses a combination of the personal identification information with a nonce (a counter, a time stamp, or the like) as a cipher key in order to generate plural cipher keys for the same personal identification information. In this case, the ciphering means 320 further stores, in the storage device 20, the nonce used to cipher a text, in association with the ciphered text.

In response to an instruction from the privacy policy administrator, the deciphering means 350 causes the ciphered personal information to be read from the storage device 20. The deciphering means 350 then uses the decipher key to decipher the read personal information. Then, the deciphering means 350 compares the deciphered personal information with the personal information inputted by the inquiry target input means 340. Subsequently, the deciphering means 350 outputs the result of the comparison to the personal terminal 50.

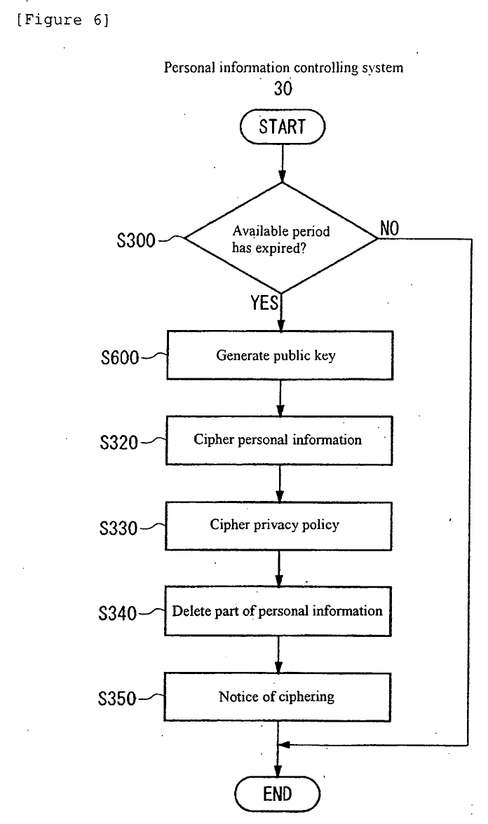

FIG. 6 shows the operational flow of a process in which the personal information controlling system 30 ciphers personal information according to a variation. The operational flow shown in this figure is substantially the same as the one shown in FIG. 3. Accordingly, only differences from the operational flow in FIG. 3 will be described. If the available period specified by the privacy policy has expired (S300: YES), the key generating means 330 generates, on the basis of the personal identification information, a cipher key for which the privacy policy administrator controls a decipher key and for which the personal information user does not control the decipher key (S600). Then, the ciphering means 320 uses the cipher key based on the personal identification information to cipher the personal information on the basis of the identity-based encryption (S320). The ciphering means 320 further ciphers the privacy policy (S330).

Specifically, this ciphering process is expressed by Equation (5), shown below.
cipher=IBEncrypt (sp, oid|did|mid|pid|c, data|policy) (5)

In this equation, IBEncrypt denotes a cipher function for the identity-based encryption. Specifically, IBEncrypt uses the cipher key generated by the key generating means 330, oid|did|mid|pid|c, to cipher data|policy. IBEncrypt then outputs cipher. Further, sp denotes a system parameter issued by the key issuing institution server 60. Furthermore, c denotes the nonce (counter, time stamp, or the like), which is used to prevent the same cipher key from being used for the same personal identification information. Desirably, c is varied for each ciphering. In the present variation, the key issuing institution server 60 may, for example, periodically change the system parameter (sP), required to decipher a ciphered text. In this case, the key issuing institution server 60 notices the personal information controlling system 30 of the changed sp. The ciphering means 320 uses the communicated sp to cipher the personal information.

Then, the ciphering means 320 stores the ciphered text resulting from the ciphering, in the storage device 20, instead of the personal information and the privacy policy. In this case, the ciphering means 320 further stores the personal identification information identified by the personal information, in the storage device 20, in association with the ciphered text. For example, the data stored by the ciphering means 320 in the storage device 20 is expressed by Equation (6), shown below.
oid|did|mid|pid|c|cipher (6)

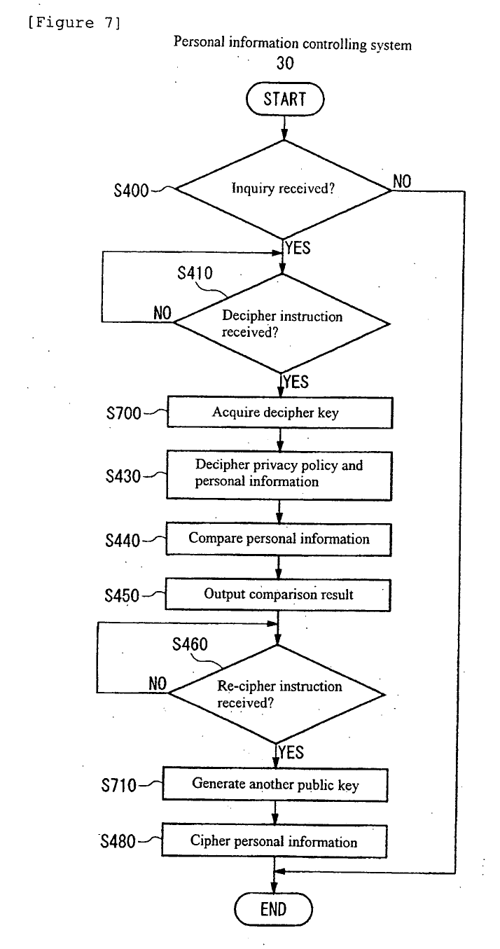

FIG. 7 shows the operational flow of a process in which the personal information controlling system 30 deciphers personal information according to a variation. The operational flow shown in this figure is substantially the same as the one shown in FIG. 4. Accordingly, only differences from the operational flow in FIG. 4 will be described. If the key acquiring means 310 receives a decipher instruction (S410: YES), it acquires a decipher key for the identity-based encryption from the key issuing institution server 60 through the process shown below (S700).

First, the key acquiring means 310 acquires the personal identification information of personal information as an inquiry target from the storage device 20. Then the key acquiring means 310 sends the personal identification information acquired to the key issuing institution server 60. The key issuing institution server 60 generates a decipher key for the identify-based encryption based on the personal identification information. The key issuing institution server 60 then returns the decipher key to the key acquiring means 310. Thus, the key acquiring means 310 can acquire the decipher key used to decipher the personal information, from the key issuing institution server 60.

For example, Equation (7), shown below, expresses the process in which the key issuing institution server 60 generates a decipher key. In this equation, IBSKGen denotes a function to generate a decipher key from cipher key in the identity-based encryption, and sk denotes the generated decipher key.
sk=IBSKGen (oid|did|mid|pid|c) (7)

In response to an instruction from the privacy policy administrator, the deciphering means 350 reads the ciphered personal information or privacy policy from the storage device 20. The deciphering means 350 then uses the decipher key to decipher the read personal information or privacy policy (S430). This process is expressed by, for example, Equation (8), shown below. In this equation, sk denotes the decipher key acquired by the key acquiring means 310 from the key issuing institution server 60.
data|policy =IBDecrypt (sp, sk, cipher) (8)

The sp used for the ciphering may differ from the sp communicated by the key issuing institution server 60 during the deciphering. In this case, the key acquiring means 310 must send the sp used for the ciphering to the key issuing institution server 60 in order to acquire the appropriate decipher key for this sp.

The processing from step S440 to step S460 is substantially the same as that shown in FIG. 4. Accordingly, its description will be omitted. If the key generating means 330 receives an instruction on re-ciphering of the deciphered personal information from the privacy policy administrator (S460: YES), it generates a cipher key different from the one for the cipher deciphered by the ciphering means 350 (S710). Specifically, the key generating means 330 generates the cipher key different from the one for the cipher deciphered by the deciphering means 350 by changing the value of the nonce c, included in the personal identification information |oid|did|mid|pid|c, used to generate the cipher key.

This makes it possible to avoid the unfair use of the secret key already disclosed to the personal information controlling system 30. Therefore, the re-ciphered personal information can be prevented from being unfairly read.

As described above, with the present variation, the personal information controlling system 30 can allow personal information to be used only during its available period as in the case of the embodiment shown in FIGS. 1 to 4. It is also possible to properly deal with an inquiry about the personal information even after the available period has expired. Moreover, in contrast to the embodiment shown in FIGS. 1 to 4, the personal information controlling system 30 need not receive any public key for the public key ciphering system from the key issuing institution server 60. Thus, the personal information controlling system 30 can reduce the cost of communications with the key issuing institution server 60 to efficiently implement the privacy policy.

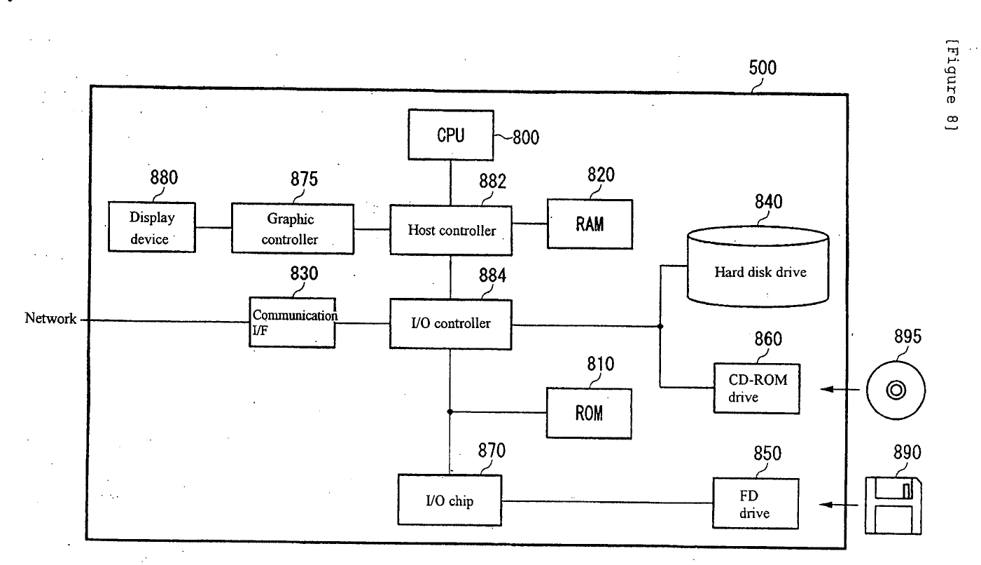

FIG. 8 shows an example of the hardware configuration of a computer 500 that realizes the personal information controlling system 3. The computer 500 comprises a CPU peripheral section having a CPU 800, a RAM 820, a graphic controller 875, and a display device 880 that are interconnected by a host controller 882, an I/O section having a communication interface 830, a hard disk drive 840, and a CD-ROM drive 860 that are connected by an I/O controller 884 to the host controller 882, and a legacy I/O section having a ROM 810, a flexible disk drive 850, and an I/O chip 870 connected to the I/O controller 884.

The host controller 882 connects the RAM 820 to the CPU 800 and graphic controller 875, which access the RAM 820 at a high transfer rate. The CPU 800 operates on the basis of programs stored in the ROM 810 and RAM 820 to control each section. The graphic controller 875 acquires image data generated by the CPU 800 or the like on a frame buffer provided in the RAM 820. The graphic controller 875 then causes the image data to be displayed on the display device 880. Alternatively, the graphic controller 875 may contain the frame buffer, which stores image data generated by the CPU 800 or the like.

The I/O controller 884 connects the host controller 882 to the communication interface 830, hard disk drive 840, and CD-ROM drive 860, which are relatively fast I-O devices. The communication interface 830 connects to an external device via the network. The hard disk drive 840 stores programs and data used by the computer 500. The CD-ROM drive 860 reads a program or data from the CD-ROM 895 and provides it to the I/O chip 870 via the RAM 820.

The I/O controller 884 connects to the ROM 810, flexible disk drive 850, I/O chip 870, and others, which are relatively slow I/O devices. The ROM 810 stores a boot program executed by the CPU 800 to activate the computer 500, programs dependent on the hardware of the computer 500, and the like. The flexible disk drive 850 reads a program or data from the flexible disk 890 and provides it to the I/O chip 870 via the RAM 820. The I/O chip 870 is connected to the flexible disk 890 and to various I/O devices via, for example, a parallel port, a serial port, a keyboard port, or a mouse port.

A program provided by the user to the computer 500 is stored in a recording medium such as the flexible disk 890, the CD-ROM 895, or an IC card. The program is read from the recording medium via the I/O chip 870 and/or I/O controller 884 and is installed in the computer 500 for execution.

The program installed in the computer 500 for execution includes a control module, a key acquiring module, a ciphering module, an inquiry target input module, a deciphering module, and a key generating module. Operations performed by the computer 500 under the control of each module are the same as those of the corresponding members of the personal information controlling system 30, described in FIGS. 1 to 7. Accordingly, their description will be omitted.

The program shown above may be stored in an external storage medium. Besides the flexible disk 890 or the CD-ROM 895, the following may be used as storage medium: an optical recording medium such as a DVD or a PD, a magnetic optic recording medium such as an MD, a tape medium, a semiconductor memory such as an IC card, etc.

Alternatively, the storage medium may be a storage device such as a hard disk or a RAM which is provided in a server system connected to a private communication network or the Internet. In this case, the program may be provided to the computer 500 via the network.

As shown above, the personal information controlling system 30 ciphers the personal information stored in the storage device 20 instead of deleting it so that the personal information user cannot use the personal information if the available period in which the personal information is allowed to be used has expired. This enables the personal information to be falsely deleted and allowed to be used only during its available period. Furthermore, it is also possible to properly deal with an inquiry about the personal information even after the available period has expired.

The embodiments of the present invention have been described. However, the scope of the present invention is not limited to the one described in the above embodiments. It is apparent to those skilled in the art that various changes or modifications may be made to the above embodiments. It is apparent from the description of the claims that such changed or modified embodiments are also included in the scope of the present invention.

The embodiments and variations shown above realize the personal information controlling system, information processing system, personal information controlling method, program, and storage medium shown in the following items.

(Item 1) A personal information controlling system that limits use of personal information stored in a storage device, the system comprising controlling means for controlling a privacy policy for each piece of personal information in connection with a specified available period in which a user of the personal information is allowed to use the personal information, the privacy policy being information specifying the available period, key acquiring means for acquiring a cipher key for a cipher that can be deciphered by an administrator of the privacy policy and that cannot be deciphered by the user of the personal information, and ciphering means for using the cipher key acquired by the key acquiring means to cipher the personal information so that the user cannot use the personal information if the available period specified by the privacy policy has expired.

(Item 2) The personal information controlling system according to Item 1, wherein the controlling means controls the privacy policy by storing it in the storage device in association with the personal information, and if the available period specified by the privacy policy has expired, the ciphering means uses the cipher key to further cipher the privacy policy and deletes a part of the personal information which corresponds to the privacy policy.

(Item 3) The personal information controlling system according to Item 1, wherein the cipher key acquired by the key acquiring means acquires, as the cipher key, a public key for a public key ciphering system for which the administrator controls a secret key and for which the user does not control the secret key, and the ciphering means ciphers the personal information using the public key.

(Item 4) The personal information controlling system according to Item 3, wherein the key acquiring means acquires different public keys for respective pieces of personal information to be ciphered, and the ciphering means carries out ciphering using the different public keys for the respective pieces of personal information.

(Item 5) The personal information controlling system according to Item 3, further comprising deciphering means for deciphering the personal information in response to an instruction form the administrator, and wherein the key acquiring means acquires a public key different from the public key for the cipher deciphered by the deciphering means if the key acquiring means receives an instruction from the administrator on re-ciphering of the deciphered personal information, and the ciphering means re-ciphers the personal information using the public key acquired by the key acquiring means.

(Item 6) The personal information controlling system according to Item 1, further comprising key generating means for generating a cipher key for a cipher for which the administrator controls a decipher key and for which the user does not control the decipher key, on the basis of personal identification information that identifies an individual specified by the personal information, wherein the key acquiring means acquires the cipher key generated by the key generating means, and the ciphering means uses the cipher key based on the personal identification information to cipher the personal information using an identity-based encryption.

(Item 7) The personal information controlling system according to Item 1, further comprising inquiry target input means for receiving an inquiry as to whether or not a piece of personal information is unfairly used, together with this piece of personal information; and deciphering means for deciphering the personal information stored in the storage device after being ciphered, in response to an instruction from the administrator and comparing the deciphered personal information with the personal information inputted by the inquiry target input means to output the result of the comparison.

(Item 8) The personal information controlling system according to Item 1, wherein after ciphering the personal information, the ciphering means further outputs a notice to a terminal of an individual identified by the ciphered individual information, the notice indicating that the ciphering means has ciphered the personal information.

(Item 9) An information processing system comprising a personal information controlling system that limits use of personal information stored in a storage device, wherein the personal information controlling system having controlling means for controlling a privacy policy for each piece of personal information in connection with a specified available period in which a user of the personal information is allowed to use the personal information, the privacy policy being information specifying the available period, key acquiring means for acquiring a cipher key for a cipher that can be deciphered by an administrator of the privacy policy and that cannot be deciphered by the user of the personal information, and ciphering means for using the cipher key acquired by the key acquiring means to cipher the personal information so that the user cannot use the personal information if the available period specified by the privacy policy has expired; and a user terminal of a user that uses the personal information stored in the storage device, wherein the user terminal reads and uses the personal information during the available period specified by the privacy policy based on the instruction of the user.

(Item 10) The information processing system according to Item 9, wherein the storage device stores plural pieces of personal information, and the user terminal uses the personal information by reading, from the storage device, plural pieces of personal information which are included in the above plural pieces of personal information and which are not deciphered by the deciphering means, to generate statistical data on the plural pieces of personal information for use.

(Item 11) The information processing system according to Item 9, wherein the personal information contains an e-mail address, and the user terminal uses the personal information by reading personal information that is not ciphered by the ciphering means, from the storage device, to transmit an advertising e-mail to the e-mail address contained in the personal information.

(Item 12) A personal information controlling method that limits use of personal information stored in a storage device of a computer, the method comprising a controlling step executed by the computer to control a privacy policy for each piece of personal information in connection with a specified available period in which a user of the personal information is allowed to use the personal information, the privacy policy being information specifying the available period, a key acquiring step executed by the computer to acquire a cipher key for a cipher that can be deciphered by an administrator of the privacy policy and that cannot be deciphered by the user of the personal information, and a ciphering step executed by the computer to use the cipher key acquired by the key acquiring means to cipher the personal information so that the user cannot use the personal information if the available period specified by the privacy policy has expired.

(Item 13) A program products that is executed on a computer to work as a personal information controlling system that limits use of personal information stored in a storage device, the program products comprising a computer-readable storage medium having computer-readable program code means embodied in the medium, the computer-readable program code means comprising controlling means for controlling a privacy policy for each piece of personal information in connection with a specified available period in which a user of the personal information is allowed to use the personal information, the privacy policy being information specifying the available period, key acquiring means for acquiring a cipher key for a cipher that can be deciphered by an administrator of the privacy policy and that cannot be deciphered by the user of the personal information, and ciphering means for using the cipher key acquired by the key acquiring means to cipher the personal information so that the user cannot use the personal information if the available period specified by the privacy policy has expired.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1) A personal information controlling system that limits use of personal information stored in a storage device, the system comprising:
controlling means for controlling a privacy policy for each piece of personal information in connection with a specified available period in which a user of said personal information is allowed to use said personal information, the privacy policy being information specifying the available period;
key acquiring means for acquiring a cipher key for a cipher that can be deciphered by an administrator of said privacy policy and that cannot be deciphered by the user of said personal information; and
ciphering means for using said cipher key acquired by said key acquiring means to cipher said personal information so that said user cannot use the personal information if the available period specified by said privacy policy has expired.

2) The personal information controlling system according to claim 1, wherein said controlling means controls said privacy policy by storing it in said storage device in association with said personal information, and
if the available period specified by said privacy policy has expired, said ciphering means uses said cipher key to further cipher said privacy policy and deletes a part of said personal information which corresponds to the privacy policy.

3) The personal information controlling system according to claim 1, wherein said cipher key acquired by said key acquiring means acquires, as said cipher key, a public key for a public key ciphering system for which said administrator controls a secret key and for which said user does not control said secret key, and
said ciphering means ciphers said personal information using said public key.

4) The personal information controlling system according to claim 3, wherein said key acquiring means acquires different public keys for respective pieces of personal information, and
said ciphering means carries out ciphering using said different public keys for the respective pieces of personal information.

5) The personal information controlling system according to claim 3, further comprising deciphering means for deciphering said personal information in response to an instruction form said administrator, and
wherein said key acquiring means acquires a public key different from the public key for the cipher deciphered by said deciphering means if said key acquiring means receives an instruction from said administrator on re-ciphering of the deciphered personal information, and
said ciphering means re-ciphers the personal information using said public key acquired by said key acquiring means.

6) The personal information controlling system according to claim 1, further comprising key generating means for generating a cipher key for a cipher for which said administrator controls a decipher key and for which said user does not control the decipher key, on the basis of personal identification information that identifies an individual specified by said personal information,
wherein said key acquiring means acquires said cipher key generated by said key generating means, and
said ciphering means uses said cipher key based on said personal identification information to cipher said personal information using an identity-based encryption.

7) The personal information controlling system according to claim 1, further comprising inquiry target input means for receiving an inquiry as to whether or not a piece of personal information is unfairly used, together with this piece of personal information; and
deciphering means for deciphering the personal information stored in the storage device after being ciphered, in response to an instruction from said administrator and comparing the deciphered personal information with the personal information inputted by said inquiry target input means to output the result of the comparison.

8) The personal information controlling system according to claim 1, wherein after ciphering said personal information, said ciphering means further outputs a notice to a terminal of an individual identified by the ciphered individual information, the notice indicating that the ciphering means has ciphered said personal information.

9) An information processing system comprising: a personal information controlling system that limits use of personal information stored in a storage device, wherein the personal information controlling system having controlling means for controlling a privacy policy for each piece of personal information in connection with a specified available period in which a user of said personal information is allowed to use said personal information, the privacy policy being information specifying the available period;
key acquiring means for acquiring a cipher key for a cipher that can be deciphered by an administrator of said privacy policy and that cannot be deciphered by the user of said personal information; and
ciphering means for using said cipher key acquired by said key acquiring means to cipher said personal information so that said user cannot use the personal information if the available period specified by said privacy policy has expired; and a user terminal of a user that uses said personal information stored in said storage device,
wherein said user terminal reads and uses said personal information during the available period specified by the privacy policy based on the instruction of said user.

10) The information processing system according to claim 9, wherein said storage device stores plural pieces of personal information, and
said user terminal uses the personal information by reading, from said storage device, plural pieces of personal information which are included in said plural pieces of personal information and which are not deciphered by said deciphering means, to generate statistical data on the plural pieces of personal information.

11) The information processing system according to claim 9, wherein said personal information contains an e-mail address, and
said user terminal uses the personal information by reading personal information that is not deciphered by said deciphering means, from said storage device, to transmit an advertising e-mail to said e-mail address contained in the personal information.

12) A personal information controlling method that limits use of personal information stored in a storage device of a computer, the method comprising:
a controlling step executed by said computer to control a privacy policy for each piece of personal information in connection with a specified available period in which a user of said personal information is allowed to use said personal information, the privacy policy being information specifying the available period;
a key acquiring step executed by said computer to acquire a cipher key for a cipher that can be deciphered by an administrator of said privacy policy and that cannot be deciphered by the user of said personal information; and
a ciphering step executed by said computer to use said cipher key acquired by said key acquiring means to cipher said personal information so that said user cannot use the personal information if the available period specified by said privacy policy has expired.

13) A program product that is executed on a computer to work as a personal information controlling system that limits use of personal information stored in a storage device, the program products comprising a computer-readable storage medium having computer-readable program code means embodied in the medium, the computer-readable program code means comprising:
controlling means for controlling a privacy policy for each piece of personal information in connection with a specified available period in which a user of said personal information is allowed to use said personal information, the privacy policy being information specifying the available period;
key acquiring means for acquiring a cipher key for a cipher that can be deciphered by an administrator of said privacy policy and that cannot be deciphered by the user of said personal information; and
ciphering means for using said cipher key acquired by said key acquiring means to cipher said personal information so that said user cannot use the personal information if the available period specified by said privacy policy has expired.

14) An article of manufacture comprising a computer usable medium having computer readable program code means embodied therein for causing limitation of use of personal information stored in a storage device of a computer, the computer readable program code means in said article of manufacture comprising computer readable program code means for causing a computer to effect the steps of claim 10.

15) A program storage device readable by machine, tangibly embodying a program of instructions executable by the machine to perform method steps for limiting use of personal information stored in a storage device of a computer, said method steps comprising the steps of claim 10.

16) A computer program product comprising a computer usable medium having computer readable program code means embodied therein for causing limitation of use of personal information stored in a storage device of a computer, the computer readable program code means in said computer program product comprising computer readable program code means for causing a computer to effect the functions of claim 1.

17) A computer program product comprising a computer usable medium having computer readable program code means embodied therein for causing information processing, the computer readable program code means in said computer program product comprising computer readable program code means for causing a computer to effect the functions of claim 9.
